(19) United States
(12) Patent Application Publication
(10) Pub. No.: US 2013/0192426 A1
(43) Pub. Date: Aug. 1, 2013

(54) STAND FOR A CORKSCREW

(71) Applicant: Claude MAUFETTE, Montreal (CA)

(72) Inventor: Claude MAUFETTE, Montreal (CA)

(21) Appl. No.: 13/566,617

(22) Filed: Aug. 3, 2012

Related U.S. Application Data
(60) Provisional application No. 61/515,533, filed on Aug. 5, 2011.

(51) Int. Cl. B67B 7/44; B67B 7/04

(52) U.S. Cl. CPC B67B 7/44; B67B 7/04
USPC 81/3.09; 81/3.25

(57) ABSTRACT

A stand for receiving a corkscrew having a body with a bottom portion having a magnetic metallic bottom surface or a magnetic member. The stand comprises a bottom portion for contacting a horizontal surface; a top portion being opposed to the bottom portion, and a peripheral wall at least partially extending between the bottom and top portions. The top portion defines a base for receiving the corkscrew's body, the base comprising a magnetic member or a magnetic metallic upper surface adapted to magnetically affix the bottom portion of the corkscrew's body to the base.

### CROSS-REFERENCE TO RELATED APPLICATION

This application claims priority to U.S. Provisional Application No. 61/512,533 filed on Aug. 5, 2011, the contents of which are incorporated herein by reference in their entirety.

### FIELD OF THE INVENTION

The present invention relates to a stand for supporting a corkscrew in an upright position.

### BACKGROUND OF THE INVENTION

In accomplishing the task of opening a (wine) bottle sealed with a cork and foil, it has been long known to use a cutting means and corkscrew. More specifically, the cutting means is used for removing the foil from the cork while a corkscrew (comprising a spiral screw) is used to subsequently pull out the cork from the mouth of the wine bottle. Many different implementations have been conceived in the objective of rendering the overall task of opening a wine bottle easier. This has led to the creation of different types of cutters and corkscrews.

However, it is noted that many implementations have regarded the cutter and corkscrew as being two separate entities with no connection to each other than the functional relationship of opening a wine bottle. As such, these items are often stored separately therefore increasing the likelihood of misplacing either one of them. There is therefore a need for a convenient method of keeping a cutter and a corkscrew together when they are not in use.

At best, prior implementations comprise a stand upon which a corkscrew may be mounted while providing an opening within the stand for placing a cutter, thus keeping the corkscrew and the cutter together while each of these is mounted on the stand. However, it is noted that the stand provides for an additional item to manufacture. Furthermore, depending on the complexity of the design of the stand, this additional item may prove to present additional costs without providing additional functionality regarding the actual task of opening a wine bottle.

In contrast, the present invention covers a stand which may also accomplish the function of a cutter. As such, the stand presents two uses: supporting or receiving the corkscrew via magnetic means and cutting the foil off a bottle.

### SUMMARY OF THE INVENTION

According to a first aspect of the present invention, there is provided a stand for receiving a corkscrew having a body with a bottom portion having a magnetic metallic bottom surface or a magnetic member. The stand comprises a bottom portion for contacting a horizontal surface; a top portion being opposed to the bottom portion, and a peripheral wall at least partially extending between the bottom and top portions. The top portion defines a base for receiving the corkscrew's body, the base comprising a magnetic member or a magnetic metallic upper surface adapted to magnetically affix the bottom portion of the corkscrew's body to the base.

According to another aspect of the present invention, there is provided a combination comprising: a corkscrew having a body with a bottom portion having a magnetic metallic bottom surface or a magnetic member; and a stand for receiving the corkscrew, the stand comprising (i) a bottom portion for contacting a horizontal surface; (ii) a top portion being opposed to the bottom portion, and (iii) a peripheral wall at least partially extending between the bottom and top portions. The top portion defines a base for receiving the corkscrew's body, the base comprising a magnetic member or a magnetic metallic upper surface adapted to magnetically affix the bottom portion of the corkscrew's body to the base.

This and other aspects and features of the present invention will now become apparent to those of ordinary skill in the art upon review of the following description of specific embodiments of the invention and the accompanying drawings.

### BRIEF DESCRIPTION OF THE DRAWINGS

A detailed description of examples of implementation of the present invention is provided hereinbelow with reference to the following drawings, in which:

FIG. 1 shows a rear top perspective view of a stand in accordance with a non-limiting embodiment of the invention, where a corkscrew is mounted on the stand;

FIG. 2 shows a rear top perspective view of the stand and corkscrew of FIG. 1, the corkscrew being shown just before being removed from the stand;

FIG. 3 shows a side view of the stand and corkscrew of FIG. 2;

FIG. 4 shows a rear top perspective view of the stand of FIG. 1;

FIG. 5 shows a front view of the stand of FIG. 4;

FIG. 6 shows a rear view of the stand of FIG. 4;

FIG. 7 shows a side view of the stand of FIG. 4;

FIG. 8 shows a top view of the stand of FIG. 4;

FIG. 9 shows a bottom view of the stand of FIG. 4;

FIG. 10 is an enlarged top perspective view of the stand of FIG. 4, where the stand is used for cutting the foil of a bottle and has an actuator shown in a first position in broken lines and in a second position in full lines;

FIG. 11A is a bottom view of a non-limiting embodiment of the stand of FIG. 10, where the actuator is in the second position;

FIG. 11B is a bottom view of another non-limiting embodiment of the stand of FIG. 10, where the actuator is in the second position;

FIG. 11C is a bottom view of yet another non-limiting embodiment of the stand of FIG. 10, where the actuator is in the second position;

FIG. 12 is a rear top perspective view of the corkscrew to be mounted to the stand;

FIG. 13 is a side view of the corkscrew to be mounted to the stand;

FIG. 14 is a bottom view of the corkscrew;

FIG. 15 is an elevational view of a bottle; and

FIG. 16 shows a partial, enlarged cross-sectional view of the bottle of FIG. 15 taken along line 16-16.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION OF THE EMBODIMENTS OF THE INVENTION

To facilitate the description, any reference numeral designating an element in one figure will designate the same element if used in any other figures. In describing the embodiments, specific terminology is resorted to for the sake of clarity but the invention is not intended to be limited to the specific terms so selected, and it is understood that each specific term comprises all equivalents.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure. Similarly, the terms “inwardly,” “outwardly” and “radially” generally refer to the orientation of a surface relative to its axis of elongation, or axis of rotation, as appropriate.

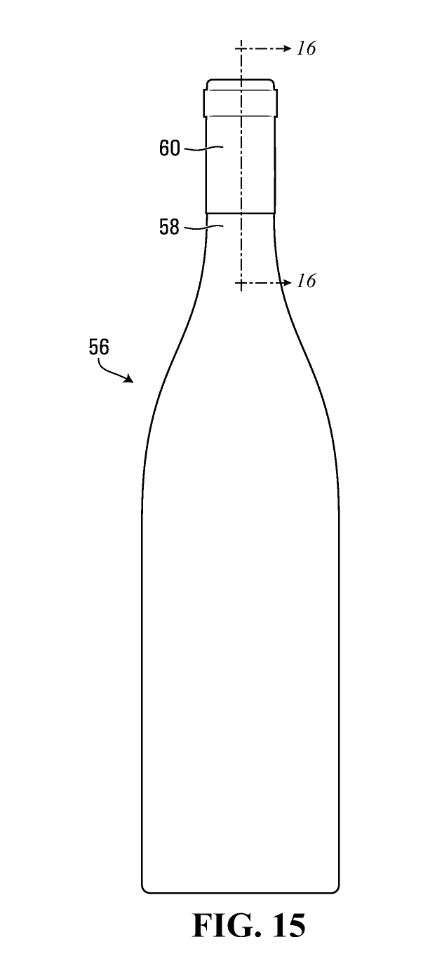

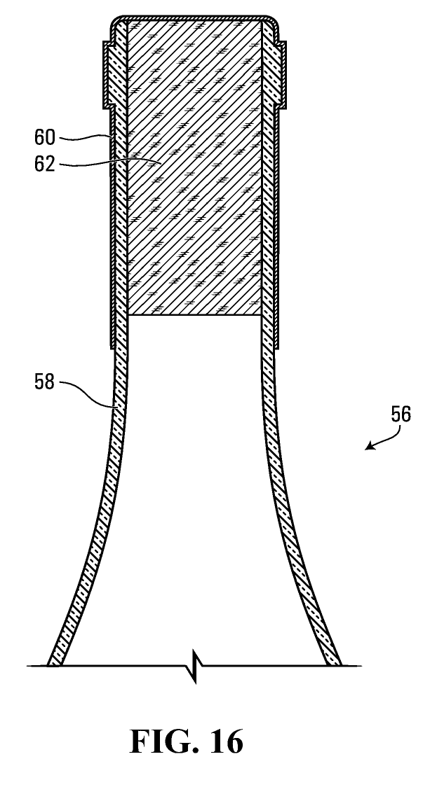

FIG. 15 shows a bottle 56 having a neck 58. As it is well known in the art, most bottles are sealed with a cork 62 (see FIG. 16) and have a protective sleeve called a capsule (commonly referred to as a “foil”) at least partially covering the bottle neck 58 (see the foil 60 in FIGS. 15 and 16). Capsules were historically made of lead, and protected the cork from being gnawed away by rodents or infested with cork weevil. Most capsules or foils are today made of tin, polyethylene, aluminum or polylaminate aluminum.

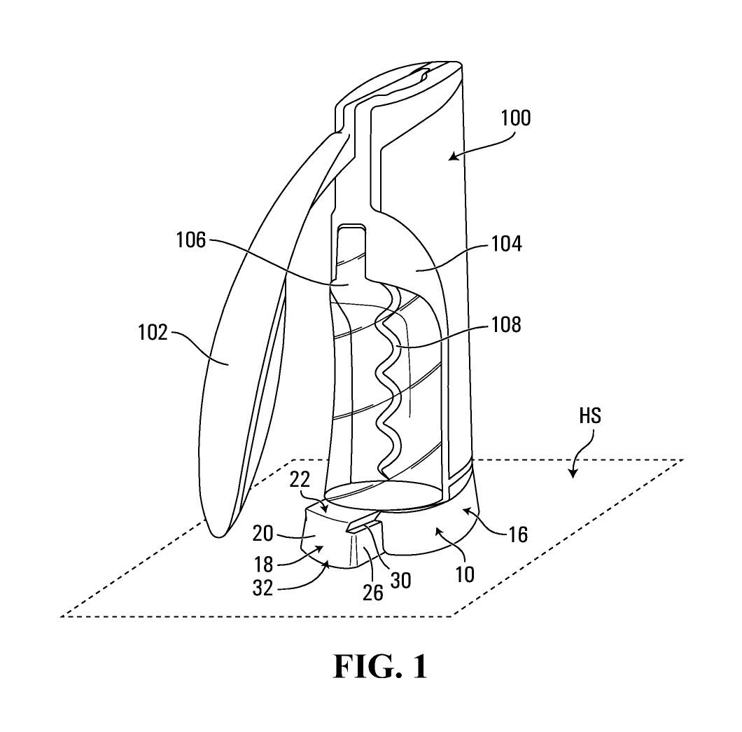

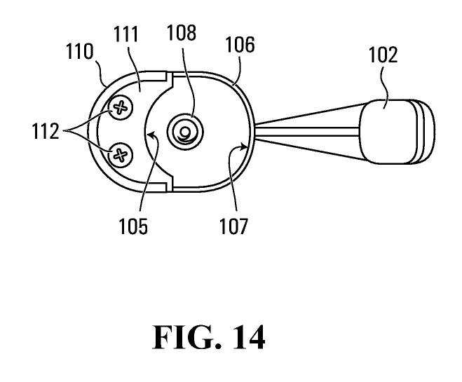

FIGS. 1 to 3 and 14 show a corkscrew 100 that has a lever (handle) 102, a body 104 with an inner wall 105 (best shown in FIG. 14), an arm 106 pivotally mounted to the body 104 and having an inner wall 107 (also shown in FIG. 14), and a spiral screw 108. The corkscrew 100 may have a rotator held within an annular casing provided in the body 104. An example of a corkscrew is shown in CA Patent Application 2,304,836 published on Oct. 11, 2001, the contents of which are incorporated herein by reference.

It can be appreciated that the corkscrew 100 may be entirely or partly made of stainless steel, zinc, plastic or other suitable materials. For example, the body 104 may be entirely or partly made of plastic or stainless steel and may have a bottom portion made of zinc or covered entirely or partly by a cover made of zinc.

The body 104 has a bottom portion 110 having a magnetic portion 111 comprising a metallic bottom surface or a magnetic member. The magnetic metallic bottom surface may be entirely or partly made from a magnetic metal such as iron, steel or nickel.

In one embodiment, the magnetic metallic bottom surface of the bottom portion 110 may comprise one or more elements or screws 112 mounted or affixed therein and made from a magnetic metal such as iron, steel or nickel.

In another embodiment, the bottom portion 110 may have a magnetic member, which can be mounted in a housing provided in the bottom portion 110 or may be affixed to the bottom portion 110.

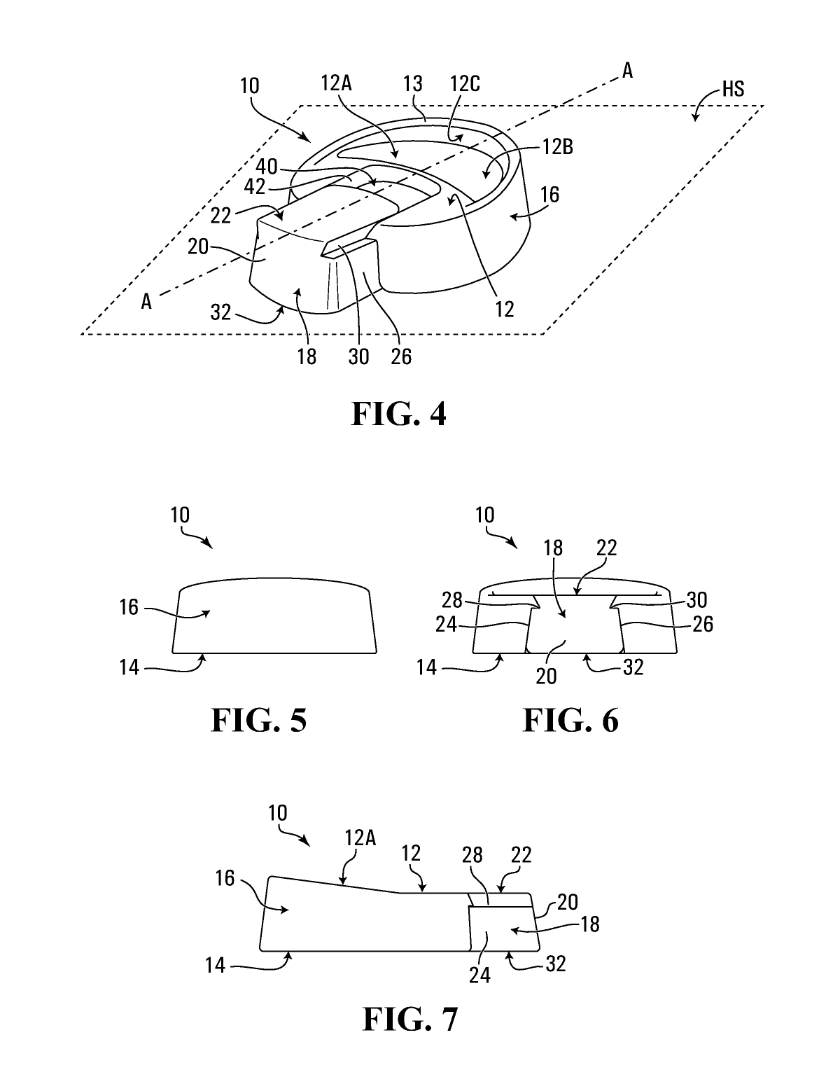

Referring to FIGS. 4 to 11C, a stand 10 for supporting the corkscrew 100 is shown. The stand comprises a top portion 12, a bottom portion 14 being opposed to the top portion 12 and a peripheral wall 16 at least partially extending from the top portion 12 to the bottom portion 14. With reference to FIG. 4, the stand 10 may have a generally elongated shape such that the stand 10 may be seen as extending along a longitudinal axis A-A.

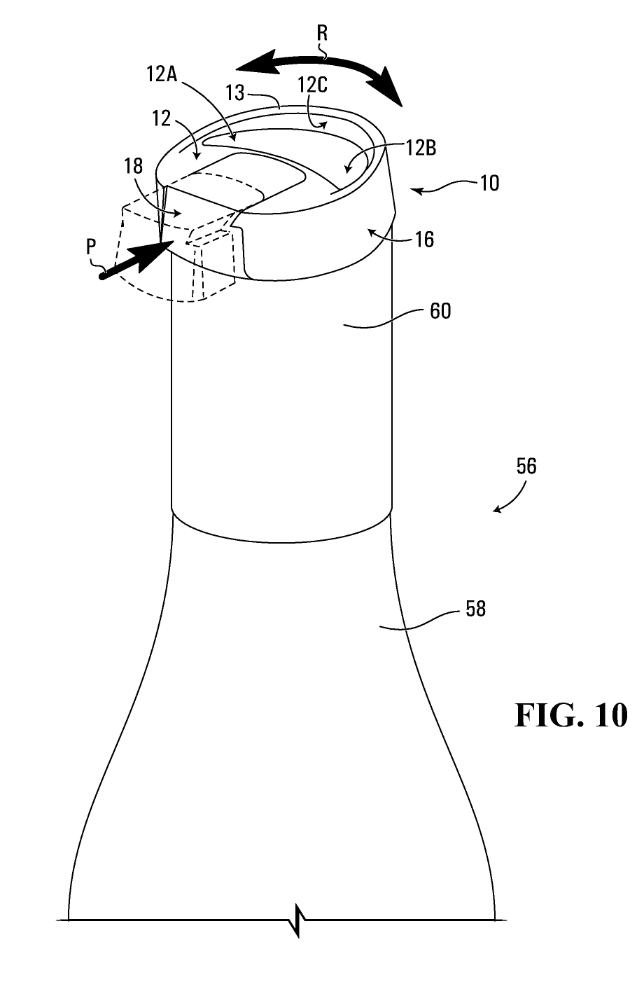

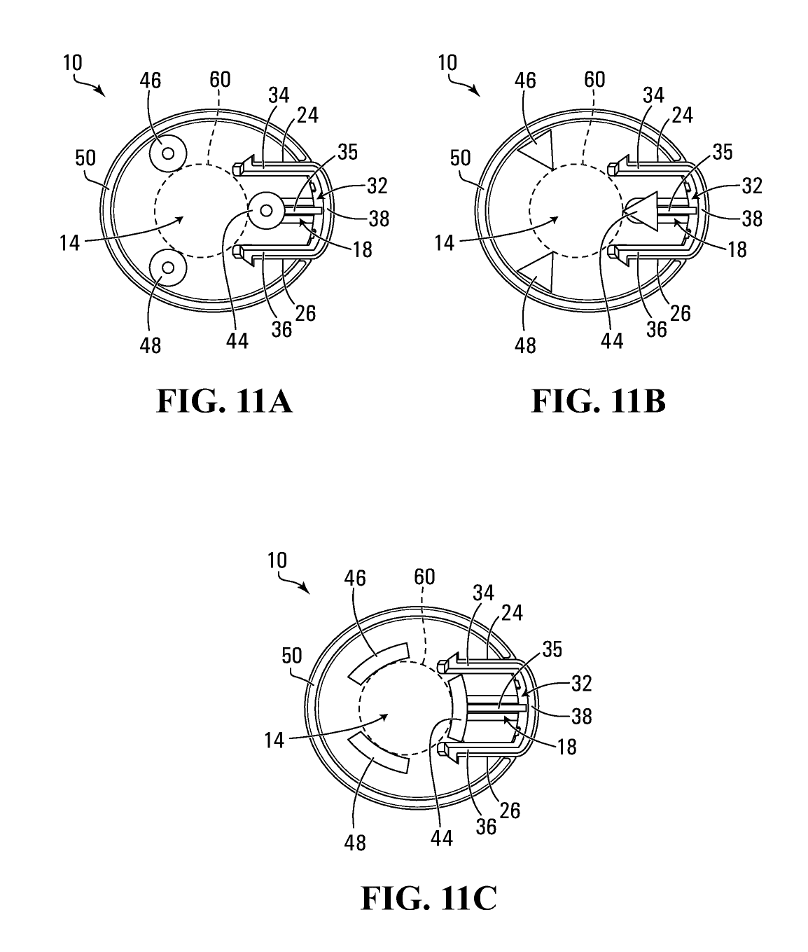

The stand 10 also comprises an actuator (button) 18 having a finger or thumb wall 20 that is accessible by a finger or thumb of a user such that the user can press the actuator 18 from a first position, shown in full lines in FIG. 4 and in broken lines in FIG. 10, to a second position, shown in full lines in FIGS. 10 to 11C. The actuator 18 also comprises a top portion 22, left and right side walls 24, 26 having left and right grooves 28, 30 and a bottom portion 32 having left, middle and right projections 34, 35, 36 projecting downwardly therefrom.

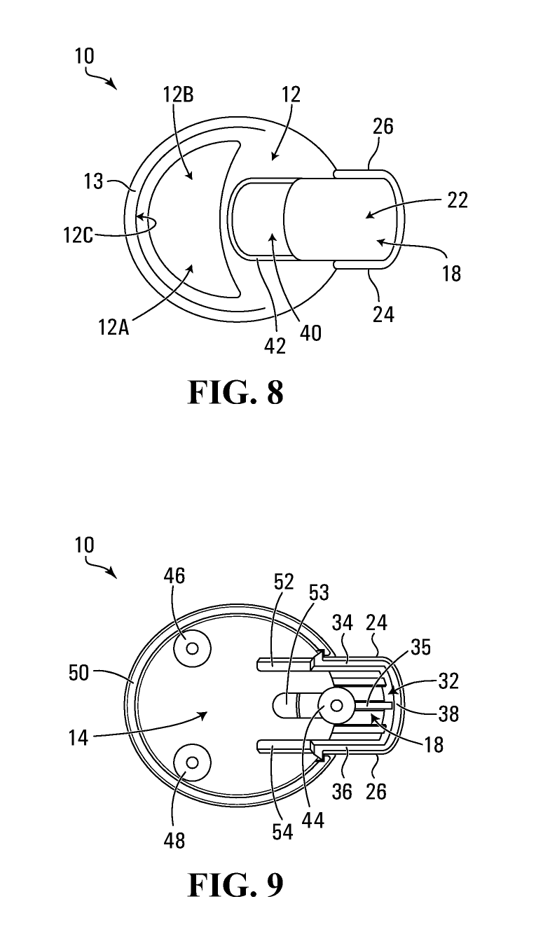

As best seen in FIGS. 4 and 8, the stand 10 has an open slot 40 defined by an inner wall 42, the open slot 40 being open at one end for receiving the actuator 18 and extending along the longitudinal axis A-A. The inner wall 42 projects inwardly to register with the grooves 28, 30 provided on each side wall of the actuator 18.

As shown in FIGS. 9 and 11A to 11C, the stand 10 further comprises first, second and third circular blades 44, 46, 48 each having a generally consistently sharp circular cutting edge. The blades 44, 46, 48 may be made of stainless steel. The first blade 44 may be mounted to a bottom portion of the actuator 18 and the second and third blades 46, 48 may be mounted to the bottom portion of the stand 10.

The corkscrew 100 is adapted to be used in two configurations. In a first configuration shown in FIGS. 1 to 3, the corkscrew 100 rests in an upright position on the top portion 12 of the stand 10, and in a second configuration, the corkscrew 100 no longer rests on the top portion 12 of the stand 10 and can be used for opening the bottle 56.

The stand 10 is also adapted to be used in two configurations. In a first configuration shown in FIGS. 1 to 3, the bottom portion 14 of the stand 10 rests on a horizontal surface HS (schematically identified by in FIGS. 1 to 4, 12 and 13), and in a second configuration best shown in FIGS. 10 and 11A, the stand 10 is adapted to be placed around the foil 60 of the bottle neck 58 and, in use, the first blade 44 is movable from a first position, wherein the first blade 44 does not contact the foil, to a second position, wherein each of the first, second and third blades 44, 46, 48 contacts the foil 60 and the user can turn the stand such that each of the first, second and third blades 44, 46, 48 cuts the foil 60. It is understood that, in the first configuration, the corkscrew may also rest in an upright position on the base of the stand, and in the second configuration, the corkscrew no longer rests on the base of the stand.

In one embodiment, the blades 44, 46, 48 may be pivotally mounted to the bottom portion 32 of the actuator 18 and the bottom portion 14 of the stand 10. In another embodiment, the blades 44, 46, 48 may be fixedly mounted to the actuator 18 and stand 10.

It is to be understood that the blades 44, 46, 48 may have any shape designed to substantially abut against a circular surface such as when cutting a foil 60 from the top of a bottle neck 58 as explained in further detail below. For example, in some embodiments, the blades 44, 46, 48 may be designed with a pointed cutting edge (FIG. 11B). In yet another embodiment (FIG. 11C), the blades 44, 46, 48 may have a curved edge adapted to receive and abut against the curved surface of different sized bottles. More specifically, in such an embodiment, the cutting edge of the blades 44, 46, 48 may have a radius of curvature slightly greater that the standard radius of curvature of the outer diameter of the neck of a wine bottle (approximately 18.5 mm). In a more specific embodiment, the blades of FIG. 11C can have a serrated cutting edge as opposed to having a generally consistently sharp cutting edge.

Although the embodiments shown in FIGS. 11A through 11C show the blades 44, 46, 48 as being of the same type, it can be understood that any combination of blades 44, 46, 48 as depicted in FIGS. 11A through 11C and as discussed above may be achieved without departing from the scope of the present invention. For example, in some embodiments, the first blade 44 may have a pointed edge while the second and third blades 46, 48 may be circular. In another embodiment, at least one of the blades 44, 46, 48 may be serrated. It is understood that other relevant combinations may be contemplated and as such are not further discussed herein.

In addition, although the embodiments depicted in the figures include three blades, it can be understood that any number of blades may be employed. The use of three blades is described herein due to the fact that a circle can be drawn through any three points and thus, the use of three blades allows for a tangential contact between each of the blades and the outer diameter of the mouth of the bottle given their triangular orientation with respect to one another. In addition, the use of three generally equidistant blades allows for a smaller angular rotation to fully cut the foil 60 than if a smaller number of blades is employed. However, it is also to be understood that a different number of blades can be employed while presenting this same advantage. For example, in some embodiments, four blades may be used such that they are arranged in a rectangular or square configuration with respect to one another by, for example, placing two blades on the stand 10 and two blades on the actuator 18 of the stand 10. Other variations are possible which can readily be implemented by a person of skill in the art and as such are not further discussed herein.

As best seen in FIG. 9, the bottom portion 14 of the stand 10 has a contacting surface 50 for contacting the horizontal surface HS and left, middle and right grooves 52, 53, 54 in which the left, middle and right projections 34, 35, 36 of the actuator 18 are received for sliding between the first and second positions.

It is understood that the contacting surface 50 of the stand 10 may also include a contacting surface 38 of the actuator 18, which comprises the bottom surfaces of the left and right projections 34, 36 and a remaining part of the actuator 18.

It is also understood that the contacting surfaces 50, 38 may be generally at the same level (i.e.: the contacting surfaces 50, 38 generally lie in a single plane) such that the bottom portion 14 of the stand 10 provides a stable contacting surface between the bottom portion 14 of the stand 10 and the horizontal surface HS for supporting the corkscrew 100 in its upright position as shown in FIGS. 1 to 3.

Furthermore, in some embodiments, grip promoting material can be added to the bottom portion 14 of the stand 10 or the actuator 18 for contacting the horizontal surface HS in order to further stabilize the stand 10 in relation to the horizontal surface HS. For example, in some embodiments, at least one of the contacting surfaces 50, 38 may include a grip promoting material such as rubber in order to increase the coefficient of friction between the contacting surfaces 50, 38 of the stand 10 and the horizontal surface HS. Furthermore, in other embodiments, grip promoting material may be added or incorporated to either of the peripheral wall 16 or the wall 20 of the actuator 18 of the stand 10 such as to further secure the stand 10 to the user's fingers when the stand 10 is being used to open the bottle 56.

In addition, it is to note that in the embodiments shown in the figures, the wall 20 of the actuator 18 of the stand 10 has a generally convex contour such that when the actuator 18 moves from the first position to the second position, the convex contour of the wall 20 of the actuator 18 forms a smooth surface with respect to the peripheral wall 16 of the stand 10 (i.e. the curvature of the peripheral wall 16 is generally the same than the one of the wall 20 of the actuator 18 in the region proximate the actuator 18) when the actuator is entirely confined in the groove 40. It is also understood that in some embodiments, the wall 20 of the actuator 18 may have a generally concave central portion such as to promote the receipt of a finger or thumb of a user to the wall 20 during use. It is also understood that the stand 10 or the actuator 18 may comprise one or more springs or any other biasing means wherein the springs are compressed when the actuator 18 is in the second position and wherein the springs bias or push the actuator 18 such that the actuator remains in the first position when no pressure is exerted by the user on the wall 20.

Furthermore, grip promoting material can form part of the corkscrew 100 in order to permit better handling and use of the corkscrew 100. For example, in some embodiments, a portion of the lever 102 can be made of rubber in order to improve the comfort of the user while inserting the spiral screw 108 into the cork 62 of the bottle 56. In other embodiments, a portion of the arm 106 of the corkscrew 100 can include at least one type of rubber on the inner wall 107 of the arm 106 such as to provide a more secure contact between the inner wall 107 and the outer surface of the bottle neck 58. As such, it is understood that different types of grip promoting material may be used for different purposes on either of the stand 10 or corkscrew 100.

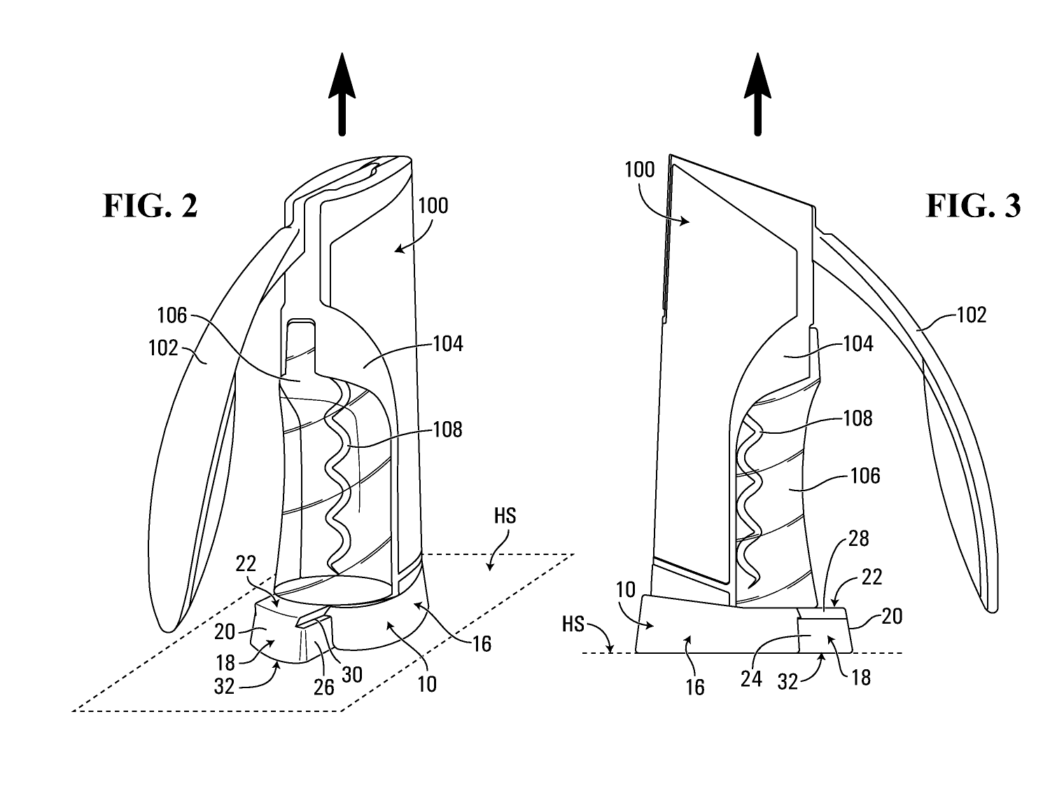

Referring to FIGS. 2 and 3, when a user wants to use the corkscrew 100 and the stand 10, he/she simply holds the stand 10 and pulls upwardly on the corkscrew 100 in order to remove the corkscrew 100 from the stand 10 (see vertical arrows showing upward movement of the corkscrew).

Once the corkscrew 100 and the stand 10 are no longer mated to one another, the user can proceed to open the bottle 56 by placing the stand 10 around the top of the bottle neck 58 (i.e.: near the mouth or opening of the bottle 56).

In use, when the user presses upon the wall 20 of the actuator 18 (see unidirectional arrow P in FIG. 10), the actuator 18 moves from the first position to the second position, wherein each of the first, second and third blades 44, 46, 48 contacts the foil 60 (schematically shown in broken lines in FIGS. 11A to 11C). The user can then rotate the stand 10 (as depicted by bidirectional arrow R in FIG. 10) such that at least one of the blades 44, 46, 48 cuts the foil 60. In the non-limiting embodiment wherein the blades 44, 46, 48 are pivotally mounted, the blades 44, 46, 48 may rotate and cut the foil 60 when the user turns the stand 10.

Once the upper part of the foil 60 is cut and removed from the bottle neck 58, the user can use the corkscrew 100 in order to remove the cork 62. To this effect, the arm 106 of the corkscrew 100 can pivot relative to the body 104 and the distal end of the lever 102 can pivot within the body 104. The arm 106 will be pivoted inwardly by the user such that the neck 58 is retained between the inner wall 105 of the body 104 and the inner wall 107 of the arm 106. At this stage, the lever 102 is in an upper position.

The user will then move the lever 102 downwardly such that the lever pivots relative to the body 104 and the spiral screw 108 turns into the cork 62. Afterwards, the user will move the lever 102 upwardly such that the lever 102 is fully raised and the cork 62 has been removed entirely from the bottle 56. The bottle 56 is then released from the inner wall 105 of the body 104 and the inner wall 107 of the arm 106 of the corkscrew 100 such that the cork 62 can be removed from the spiral screw 108 by moving the lever 102 downwardly again.

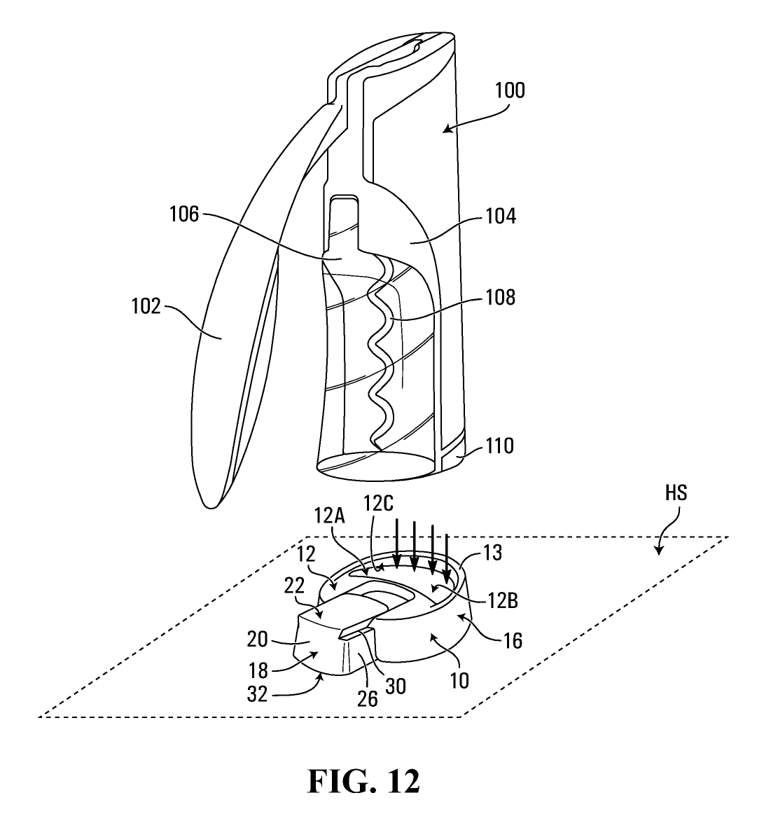

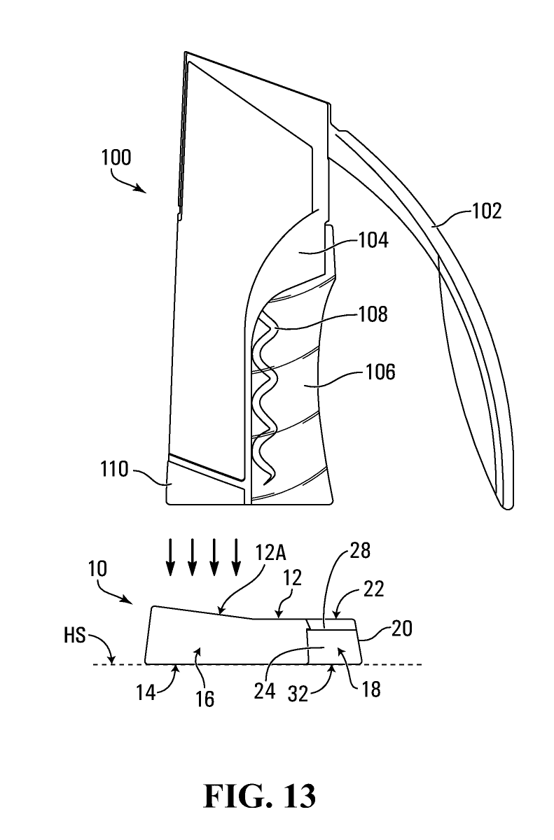

As shown in FIGS. 12 and 13, after having used the corkscrew 100, the user can mount the corkscrew 100 to the stand 10 such that the corkscrew 100 may eventually rest in the previous upright position shown in FIGS. 1 to 3.

Reverting to FIGS. 4 to 8, in order to facilitate the mounting of the corkscrew 100 to the stand 10, the top portion 12 defines a base 12A for receiving the body 104 of the corkscrew 100, the base 12A comprising a magnetic member or a magnetic metallic upper surface (see magnetic portion 12B) adapted to magnetically affix the bottom portion 110 of the corkscrew's body 104 to the base 12A.

As indicated previously, the body 104 has a bottom portion 110 with a magnetic portion 111 comprising a magnetic metallic bottom surface or a magnetic member. The magnetic metallic bottom surface may be entirely or partly made from a magnetic metal such as iron, steel or nickel. In another embodiment, the magnetic metallic bottom surface of the bottom portion 110 may comprise one or more screws 112 mounted or affixed therein and made from a magnetic metal such as iron, steel or nickel. It is understood that the magnetic metallic screws 112 may be replaced by any magnetic metallic elements mounted to the bottom surface of the bottom portion 110.

The magnetic portion 12B of the stand 10 may comprise a magnetic member. The magnetic member may comprise one permanent magnet made from a material that is magnetized and creates its own constant magnetic field. The magnetic portion 12B may also comprise at least two permanent magnets. The permanent magnet(s) may be made from iron, nickel or cobalt.

The magnetic portion 12B of the stand 10 may be mounted in a housing provided in the base 12A of the stand 10 or may be affixed to the base 12A of the stand 10. In another embodiment, the magnetic portion 12B may comprise two or more permanent magnets located in a housing provided in the base 12A of the stand 10 and covered by a top cover made of stainless steel.

In a further embodiment, the magnetic portion 12B of the stand 10 may be a magnetic metallic upper surface and the bottom portion 110 of the corkscrew's body 104 may have a magnetic member, which can be mounted in a housing provided in the bottom portion 110 or may be affixed to the bottom portion 110. The magnetic member of the bottom portion 110 may comprise one or two permanent magnets made from a material that is magnetized and creates its own constant magnetic field. The permanent magnet(s) may be made from iron, nickel or cobalt. As for the magnetic metallic bottom surface of the bottom portion 110 of the corkscrew's body 104, the magnetic metallic upper surface of the base 12A may be entirely or partly made from a magnetic metal such as iron, steel or nickel. In another embodiment, the magnetic metallic upper surface of the base 12A may comprise one or more screws or elements mounted or affixed therein and made from a magnetic metal such as iron, steel or nickel.

As briefly discussed above, it can be understood that the stand 10 and actuator 18 may be made of a variety of suitable materials. For example, in some embodiments, lighter materials such as plastics may be used to form part the stand 10 and actuator 18 in order to reduce its total weight. More specifically, in some embodiments, it may be desirable to use light materials for some parts of the stand 10 and actuator 18 such that their total weight will not induce a disconnection between the bottom portion 110 of the corkscrew's body 104 and the magnetic portion 12B of the stand if the combination corkscrew/stand is picked up to be displaced from one location to another. It is also understood that the number and material of the magnetic members and/or permanent magnets and/or magnetic metallic surfaces and/or magnetic metallic screws/elements provided in or mounted to the bottom portion 110 of the corkscrew's body 104 and/or provided in or mounted to the base 12A of the stand 10 may generate a magnetic field that is strong enough to maintain in place the corkscrew 100 or to lift the corkscrew 100 and the stand 10 together. As such, it is less likely that the corkscrew 100 and stand 10 are separated from one another.

As best shown in FIGS. 4 and 8, the base 12A of the stand 10 may also define an upwardly projecting wall 13 that projects upwardly therefrom and having a substantially vertical surface 12C against which a portion of the corkscrew's body 104 may abut for adding more stability to the corkscrew 100 when it rests on the base 12A of the stand 10. In some embodiments, the upwardly projecting wall 13 is generally located in one region of the periphery of the base 12A (for example, generally opposite to the actuator 18). As such, some movement or relative rotation is permitted between the stand 10 and the corkscrew 100 while they are affixed to each other. In other embodiments, the stand 10 may be shaped such that the upwardly projecting wall 13 extends about a greater part of the periphery of the base 12A of the stand 10 such that substantially no movement or relative rotation is permitted between the stand 10 and the corkscrew 100 while they are affixed (or mated) to each other. For example, in such embodiments, the corkscrew 100 may be “locked” in a specific orientation relative to the stand 10 when the bottom portion 110 of the corkscrew 100 is magnetically affixed to the base 12A of the stand 10. The base 12A may therefore define a support structure with a surface that is generally horizontal and a peripheral wall section extending upwardly from the support surface (see substantially vertical surface 12C) for contacting a portion of the peripheral wall of the bottom portion 110 of the corkscrew 104.

Although the present invention has been described in considerable detail with reference to certain preferred embodiments thereof, variations and refinements are possible without departing from the spirit of the invention. Therefore, the scope of the invention should be limited only by the appended claims and their equivalents.

1. A stand for receiving a corkscrew having a body with a bottom portion having a magnetic metallic bottom surface or a magnetic member, said stand comprising:
(a) a bottom portion for contacting a horizontal surface;
(b) a top portion being opposed to said bottom portion, and
(c) a peripheral wall at least partially extending between said bottom and top portions;
wherein said top portion defines a base for receiving the corkscrew's body, said base comprising a magnetic member or a magnetic metallic upper surface adapted to magnetically affix the bottom portion of the corkscrew's body to said base.

2. A stand as defined in claim 1, wherein said stand is adapted to be used in two configurations, a first configuration wherein said bottom portion of said stand rests on the horizontal surface, and a second configuration wherein said stand can be used by a user for opening a bottle.

3. A stand as defined in claim 2, wherein said stand extends along a longitudinal axis and said peripheral wall defines an open slot and wherein said stand further comprises an actuator adapted to move in said open slot along said longitudinal axis between a first position, wherein said actuator projects from said slot, and a second position, wherein said actuator is at least partially confined in said slot when the user presses against said actuator.

4. A stand as defined in claim 3, wherein said stand further comprises a first blade mounted to a bottom portion of said actuator and second and third blades mounted to said bottom portion of said stand, wherein, in said second configuration, said stand is adapted to be placed around a foil of the bottle for opening the bottle.

5. A stand as defined in claim 4, wherein, in said first position, said first blade does not contact the foil, and in said second position, when the user presses against said actuator, each of said first, second and third blades contacts the foil and the user can turn said stand such that at least one of said first, second and third blades cuts the foil.

6. A stand as defined in claim 4, wherein at least one of said first, second and third blades comprises a circular cutting edge.

7. A stand as defined in claim 4, wherein each of said first, second and third blades comprises a circular cutting edge, and wherein said first blade is pivotally mounted to said bottom portion of said actuator, and said second and third blades are pivotally mounted to said bottom portion of said stand.

8. A stand as defined in claim 3, wherein said actuator comprises a contacting surface for contacting the horizontal surface.

9. A stand as defined in claim 1, wherein a magnetic field generated by said magnetic member of said bottom portion of the corkscrew's body or said base is strong enough to lift the corkscrew and said stand together.

10. A stand as defined in claim 1, wherein said base of said stand defines an upwardly projecting wall that projects upwardly therefrom, said upwardly projecting wall defining a substantially vertical surface against which a portion of said corkscrew's body may abut.

11. A combination comprising:
(a) a corkscrew having a body with a bottom portion having a magnetic metallic bottom surface or a magnetic member; and
(b) a stand for receiving said corkscrew, said stand comprising (i) a bottom portion for contacting a horizontal surface; (ii) a top portion being opposed to said bottom portion, and (iii) a peripheral wall at least partially extending between said bottom and top portions;
wherein said top portion defines a base for receiving said corkscrew's body, said base comprising a magnetic member or a magnetic metallic upper surface adapted to magnetically affix said bottom portion of said corkscrew's body to said base.

12. A combination as defined in claim 11, wherein said stand is adapted to be used in two configurations, a first configuration wherein said bottom portion of said stand rests on the horizontal surface and said corkscrew rests in an upright position on said base of said stand and a second configuration wherein said corkscrew no longer rests on said base of said stand and said stand can be used by a user for opening a bottle.

13. A combination as defined in claim 12, wherein said stand extends along a longitudinal axis and said peripheral wall defines an open slot and wherein said stand further comprises an actuator adapted to move in said open slot along said longitudinal axis between a first position, wherein said actuator projects from said slot, and a second position, wherein said actuator is at least partially confined in said slot when a user presses against said actuator.

14. A combination as defined in claim 13, wherein said stand further comprises a first blade mounted to a bottom portion of said actuator and second and third blades mounted to said bottom portion of said stand, wherein, in said second configuration, said stand is adapted to be placed around a foil of the bottle

15. A combination as defined in claim 14, wherein, in said first position, said first blade does not contact the foil, and in said second position, when the user presses against said actuator, each of said first, second and third blades contacts the foil and the user can turn said stand such that at least one of said first, second and third blades cuts the foil.

16. A combination as defined in claim 14, wherein at least one of said first, second and third blades comprises a circular cutting edge.

17. A combination as defined in claim 14, wherein each of said first, second and third blades comprises a circular cutting edge, and wherein said first blade is pivotally mounted to said bottom portion of said actuator and said second and third blades are pivotally mounted to said bottom portion of said stand.

18. A combination as defined in claim 13, wherein said actuator comprises a contacting surface for contacting the horizontal surface.

19. A combination as defined in claim 11, wherein a magnetic field generated by said magnetic member of said bottom portion of said corkscrew's body or said base of said stand is strong enough to lift said corkscrew and said stand together.

20. A combination as defined in claim 11, wherein said magnetic metallic bottom surface or said magnetic metallic upper surface is entirely or partly made from a magnetic metal such as iron, steel or nickel.

21. A combination as defined in claim 11, wherein said magnetic member of said bottom portion of said corkscrew's body is mounted in a housing provided in said bottom portion or being affixed to said bottom portion.

22. A combination as defined in claim 11, wherein said magnetic metallic bottom surface comprises one or more screws being affixed therein and being made from a magnetic metal selected in the group comprising iron, steel and nickel.

23. A combination as defined in claim 11, wherein said magnetic member of said bottom portion of said corkscrew's body or of said base of said stand comprises one or two permanent magnets made from a magnetic material selected in the group comprising iron, nickel or cobalt.

24. A combination as defined in claim 11, wherein said magnetic member of said base of said stand comprises one or two permanent magnets located in a housing provided in said base of said stand, said base further comprising a top cover covering said one or two permanent magnets.

25. A combination as defined in claim 11, wherein said base of said stand defines an upwardly projecting wall that projects upwardly therefrom, said upwardly projecting wall defining a substantially vertical surface against which a portion of said corkscrew's body may abut.
